(19) United States
(12) Patent Application Publication
(10) Pub. No.: US 2025/0139630 A1
(43) Pub. Date: May 1, 2025

(54) FRAUD PROTECTION SYSTEMS, METHODS, AND COMPUTER PROGRAMS FOR BLOCKCHAIN FINANCIAL TRANSACTIONS

(71) Applicant: ACI Worldwide Corp., Elkhorn, NE (US)

(72) Inventor: John Madden, Limerick (IE)

(21) Appl. No.: 18/495,506

(22) Filed: Oct. 26, 2023

(51) Int. Cl. G06Q 20/40; G06Q 20/36; G06Q 40/03

(52) U.S. Cl. CPC G06Q 20/4016; G06Q 20/367; G06Q 20/4037; G06Q 40/03

(57) ABSTRACT

Systems, methods, and computer programs for detecting and preventing fraud or criminal blockchain transactions which allow a payer or payee in a blockchain financial transaction to request fraud, anti-money-laundering or credit check screening as part of an on-chain payment. The screening is performed off-chain and employs SaaS solutions to perform the analysis, and, using a smart contract, stops the payment before it is settled if the screening fails.

### BACKGROUND

The proliferation of online banking has accelerated the use of real-time payments in lieu of cash and checks. Unfortunately, real-time payments are an attractive target for fraud because they can be initiated, cleared, and settled in seconds and are difficult to reverse once settled. Banks and other financial institutions have bolstered their fraud prevention strategies for real-time payments, but this has prompted fraudsters to target the weakest link in financial exchanges—consumers—through authorized push payment (APP) scams.

An APP scam is one where a scammer convinces a payer to authorize a payment to the scammer or a partner. Because payers initially cooperate with such scams, they are difficult to identify and halt. In centralized financial networks, these scams can be identified and stopped by central fraud analysis software operated by financial institutions. But in decentralized financial networks such as blockchains, where participants pay each other with coins, tokens, or other digital assets without going through financial institutions or other centralized and controlled infrastructure, the fraud protections offered by conventional financial institutions don't exist, putting the payer, and sometimes even the payee, at higher risk of fraud.

Blockchain fraud analysis solutions exist, but they detect fraud by analyzing data on blockchain ledgers (“on the chain”) and thus only identify fraud after it has occurred. Because blockchain payments are settled immediately with no financial intermediaries, reversing a completed fraudulent blockchain payment is nearly impossible unless the payee agrees to do so, which is particularly unlikely if the payee is also the scammer.

### SUMMARY

The present invention solves the above-described problems and related problems by providing improved systems, methods, and computer programs for detecting and preventing fraud for blockchain transactions.

With the present invention, a payer in a blockchain financial transaction can request fraud screening as part of an on-chain payment. The fraud screening can employ existing fraud SaaS solutions to perform the analysis, and, using a smart contract, stop the payment before it is settled if the fraud check fails.

In one embodiment of the invention, a payer uses a decentralized app (dApp) for a payment. The dApp includes logic to first execute a smart contract on the blockchain. The smart contract triggers a fraud screening by an off-chain SaaS fraud screening solution. If this screening identifies potential fraud, any additional legs of the payment (i.e. the actual transfer of digital assets to the payee) are cancelled by the smart contract, thus preventing the loss to fraud.

The cost of the fraud screening can be built into the smart contract and payable by the payer. Or, the fraud screening can be initially free, but if a transaction is found to be fraudulent and prevented, a charge may be levied.

Numerous advantages are realized by the invention. For example, because the invention provides on-chain fraud protection on a decentralized payment network as a built-in part of the payment, blockchain users are afforded the same fraud protection as generally provided by financial institutions but with the added benefits of transacting on a network with immediate settlement and transparent rules and fees. In addition to fraud protection, embodiments of the invention can also identify money laundering in real time, making it valuable to financial institutions transacting via blockchain. Embodiments of the invention can also provide credit checks to lenders transacting on-chain, offering additional protection to that already offered by smart contracts. By creating different smart contracts for different use cases, each can be handled differently on-chain, but still use the same off-chain SaaS solution. Moreover, as new scams and different avenues for fraud emerge, the present invention can continue to offer protection by updating the SaaS fraud screening to identify new trends. Any payments using the smart contract would use the latest protection available from the SaaS solution.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a schematic diagram of computer and communications equipment that may be used to implement aspects of the invention.

FIG. 2 is a flow diagram that depicts exemplary steps in a method of the present invention.

FIG. 3 is a flow diagram that depicts exemplary steps in another method of the present invention.

FIG. 4 is a flow diagram that depicts exemplary steps in yet another method of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

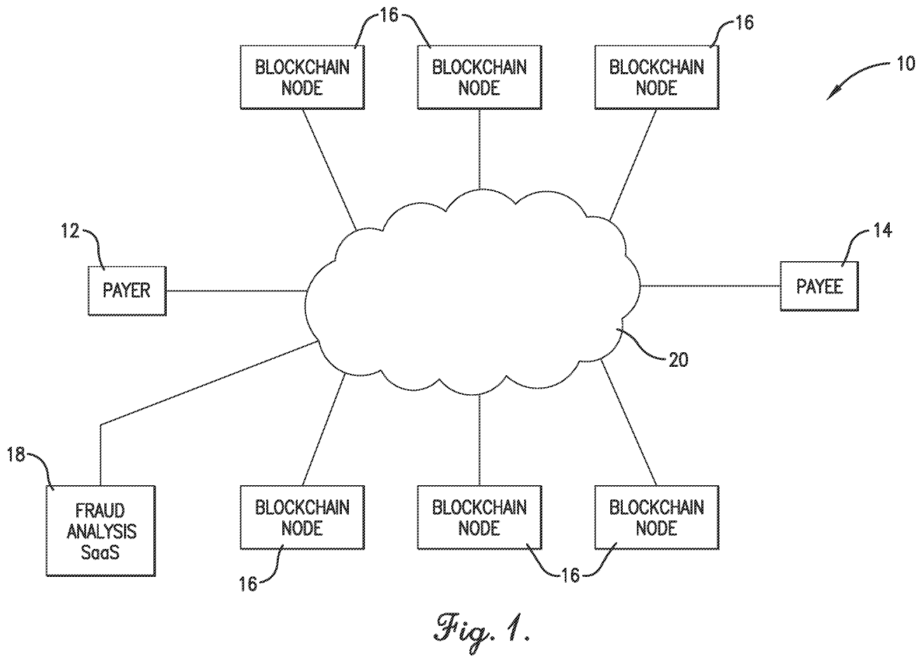

The present invention provides improved systems, methods, and computer programs for detecting and preventing fraud for blockchain transactions. Aspects of the invention can be implemented with computer and communications systems such as the system 10 depicted in FIG. 1. An embodiment of the system includes any number of computing devices 12 operated by payers (only one being shown for clarity); any number of computing devices 14 operated by payees (again, only one being shown for clarity); any number of computing devices 16 acting as nodes in a decentralized blockchain network; a computing device 18 that provides fraud analysis off the blockchain network; and a communications network 20 or networks for providing communications between the computing devices 12, 14, 16, 18.

The payer and payee computing devices 12,14 may be desktop computers, laptop computers, tablet computers, mobile phones, or any other electronic logic devices that can send and receive data via the communications network 20. The computing devices 16 that serve as blockchain nodes and the computing device 18 that provides off-chain fraud analysis may be computer servers or the like. The communications network 20 may be the Internet or any other communications network such as a local area network, a wide area network, or an intranet. The components of the system 10 illustrated and described herein are merely examples of equipment that may be used to implement embodiments of the present invention and may be replaced with other equipment without departing from the scope of the present invention. Some of the illustrated components of the system 10 may be combined, separated, and/or omitted.

The computing devices illustrated in FIG. 1 and equivalents implement one or more computer programs for performing some of the functions of the present invention. Thus, embodiments of the present invention may also comprise one or more computer programs stored in or on computer-readable medium residing on or accessible by some or all of the computing devices. The computer programs may comprise listings of executable instructions for implementing logical functions in the computing devices and can be embodied in any non-transitory computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can contain, store, or communicate the programs. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random-access memory (RAM), a read-only memory (ROM), an erasable, programmable, read-only memory (EPROM or Flash memory), an optical fiber, and a portable compact disk read-only memory (CDROM).

The above-described system 10 and the associated computer programs allow a payer in a blockchain financial transaction to request fraud screening as part of an on-chain payment. The fraud screening can employ existing fraud SaaS solutions to perform the analysis, and, using a smart contract, stop the payment before it is settled if the fraud check fails.

In one embodiment of the invention, a payer uses a decentralized app (dApp) for a payment. The dApp includes logic to first execute a smart contract on the blockchain. The smart contract triggers a fraud screening by an off-chain SaaS fraud screening solution. If this screening identifies potential fraud, any additional legs of the payment (ie. the actual transfer of digital assets to the payee) are cancelled, thus preventing the loss to fraud. The cost of the fraud screening can be built into the smart contract and payable by the payer. Or, the fraud screening can be initially free, but if a transaction is found to be fraudulent and prevented, a charge may be levied.

In one embodiment, the dApp and smart contracts reside on, and execute on, a computing device or computing devices that are part of a decentralized blockchain network. The computing device or computing devices may be one of the illustrated computing devices 16 and/or other computing devices.

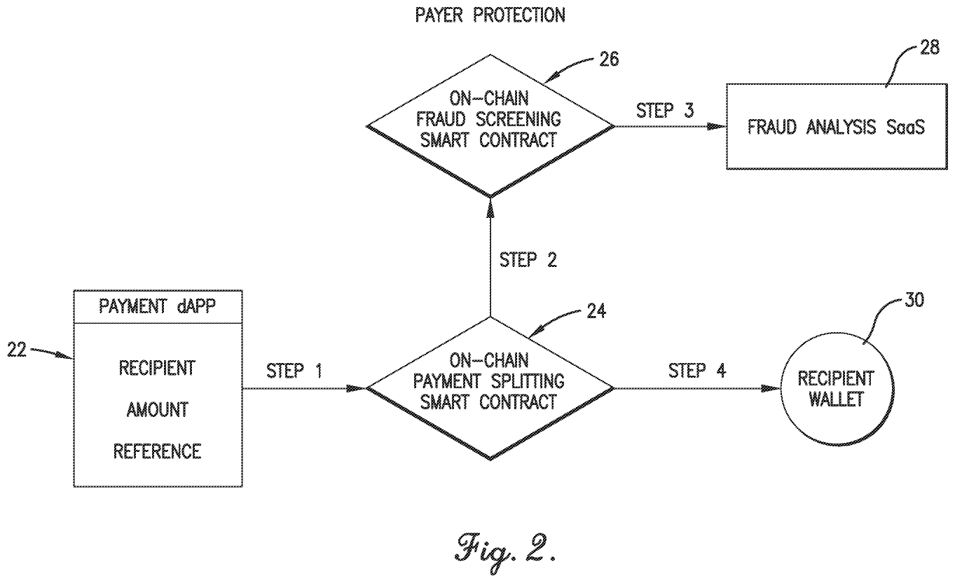

The flow chart of FIG. 2 shows the functionality and operation of an implementation of the invention for providing fraud protection to a payer. In this regard, some of the blocks of the flow chart may represent a module segment or portion of code of the computer programs of the present invention which comprises one or more executable instructions for implementing the specified logical function or functions. In some alternative implementations, the functions noted in the various blocks may occur out of the order depicted in FIG. 2. For example, two blocks shown in succession in FIG. 2 may in fact be executed substantially concurrently, or the blocks may sometimes be executed in the reverse order depending upon the functionality involved.

The method is initiated by a dApp 22 launched by the payer computing device 12. A dApp is a decentralized application built on a decentralized network that consists of a smart contract backend and a user interface frontend. The dApp communicates with a digital wallet associated with the payer. The dApp may request data from the payer such as the payee's (recipient's) name or identity, the amount of digital assets to be transferred, and some reference information.

As shown in step 1 of FIG. 2, the dApp 22 uses an on-chain payment splitting smart contract 24 to split the payment into 2 legs. A smart contract is a program stored on a blockchain that runs when predetermined conditions are met. In this case, the condition may simply be the payer's initiation of a blockchain payment. In other embodiments, the condition may also include the payer selecting/requesting fraud analysis as part of the blockchain payment (the payer may not want/need fraud analysis for every payment).

As shown by step 2, the payment splitting smart contract 24 then calls an on-chain fraud screening smart contract 26 to perform the fraud check. The payment splitting smart contract 24 and the fraud screening smart contract 26 could be combined into one but are shown here separately for illustrative purposes.

As shown by step 3, the on-chain fraud check smart contract 26 calls an off-chain fraud analysis SaaS solution 28, such as ACI Worldwide's Merchant Fraud solution, provided by the computing device 18. The call may be over existing common protocols, such as REST, gRPC or others. When the fraud analysis is complete, the results are posted back to the fraud screening smart contract 26 through a callback interface. The fraud screening smart contract 26 propagates this result back to the payment splitting smart contract 24 through a callback interface.

As shown by step 4, the second leg of the payment is completed or cancelled based on the result of the fraud analysis. If the fraud check indicates potential fraud, the payment splitting smart contract 24 cancels the second leg of the payment, preventing the transfer of funds to the payee's wallet 30. But if the fraud check doesn't indicate potential fraud, the second leg of the payment is completed, thus transferring funds to the payee's wallet.

The dApp 22 and smart contracts 24, 26 implemented with the present invention may provide the off-chain fraud analysis 28 with any data related to a blockchain transaction. The more data that is provided, the better the ability of the fraud analysis solution to determine if the payment is fraudulent. However, some data must be provided by the payer and will be different for every payment. Some data could be provided in response to a request for payment (RFP) from a merchant or service provider. Other data could be collected from prior scam payments triggered from phishing or spam emails.

The smart contracts 24, 26 could use a 3^{rd} party, such as Airnode, to relay the on-chain smart contract execution to the off-chain REST API. Or, similar functionality could be coded as part of the on-chain fraud screening smart contract 26.

Existing technical solutions, such as ACI's Merchant Fraud SaaS product, or a hosted PRM (ACI's Banking and Intermediary fraud product) would be capable of providing the real-time fraud screening 28. However, to adequately identify fraud, they would need risk strategies for this purpose. Risk strategies are built by analysing historical transactions and identifying the patterns of fraudulent behaviour, then setting up the solution with rules and AI to catch transactions matching the fraudulent patterns. This would be quite similar to adapting an existing fraud solution into a new vertical market. The data for building risk strategies on blockchain is all readily available, since the blockchain is a public ledger. There are also well-known patterns of fraudulent behaviour to be analysed, such as moving digital assets between wallets and chains to try and hide and/or obfuscate the source of the funds.

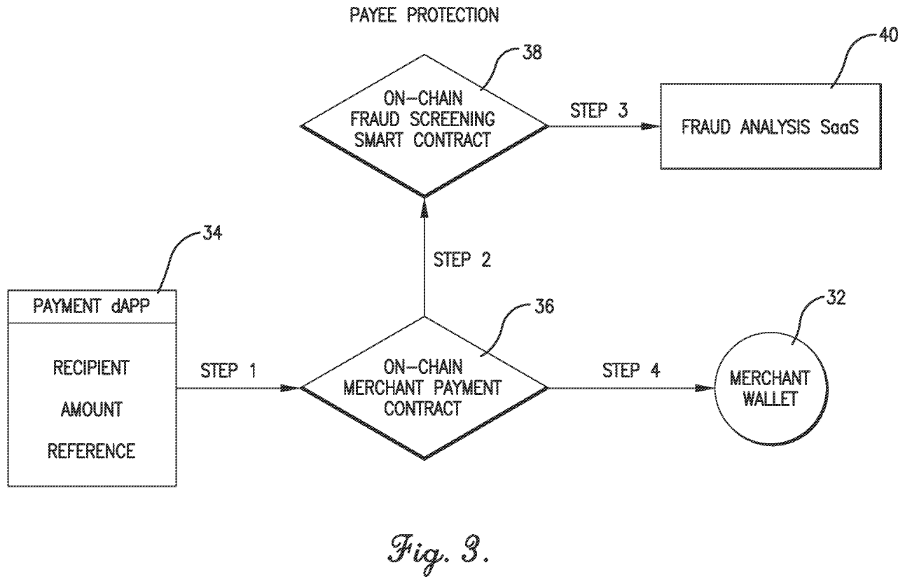

Embodiments of the present invention may also provide fraud protection to payees. The flow chart of FIG. 3 shows the functionality and operation of such an implementation of the invention. In this regard, some of the blocks of the flow chart may represent a module segment or portion of code of the computer programs of the present invention which comprises one or more executable instructions for implementing the specified logical function or functions. In some alternative implementations, the functions noted in the various blocks may occur out of the order depicted in FIG. 3. For example, two blocks shown in succession in FIG. 3 may in fact be executed substantially concurrently, or the blocks may sometimes be executed in the reverse order depending upon the functionality involved. The flow for payee protection is similar to the flow for payer protection, but it could be initiated in a similar way to current e-commerce orders. The Merchant website would offer the ability to pay with digital currency, and the payer/customer would fill out the details similar to how they do for credit card online purchases today.

As depicted by step 1 of FIG. 3, instead of transferring digital assets or funds directly to the payee's/merchant's wallet 32, a dApp 34 sends a request to an on-chain merchant payment smart contract 36 under the merchant's control. The request may be sent from something other than a dApp. For example, the request could be sent from a blockchain wallet or other means, such as a payment initiated either off-chain, or on another blockchain which passes through an exchange to complete the payment with the merchant. The smart contract 36 splits the payment, first calling an on-chain fraud screening smart contract 38.

Steps 2-4 are similar to the steps in the payer protection flow of FIG. 2 and execute the fraud screening 40 and complete the payment if fraud checks pass.

The flow shown in FIG. 3 can also be used for Anti-Money Laundering (AML) screening to prevent a transfer of funds that matches money laundering patterns. The recipient can screen the inbound payment for money laundering characteristics before accepting it. The on-chain flow would look the same, but the payload of the inbound payment would contain different details, and the off-chain Fraud Analysis SaaS solution 40 would need to be set up with rules to identify and reject money laundering.

The smart contracts for payee protection could be stricter than the ones for payer protection but would work in effectively the same way. There would be more mandatory elements in the API that the merchant would have to provide. It could also provide additional optional information, such as the customer's IP address, device identifier and similar. Again, this additional information helps provide more accurate fraud screening.

The Fraud Analysis SaaS 40 would need a dedicated risk strategy to identify money laundering. ACI's Merchant Fraud SaaS solution could fit this use case with minimal adjustment. Some of the risk strategies which depend on card number could be adapted to use source wallet address as an alternative.

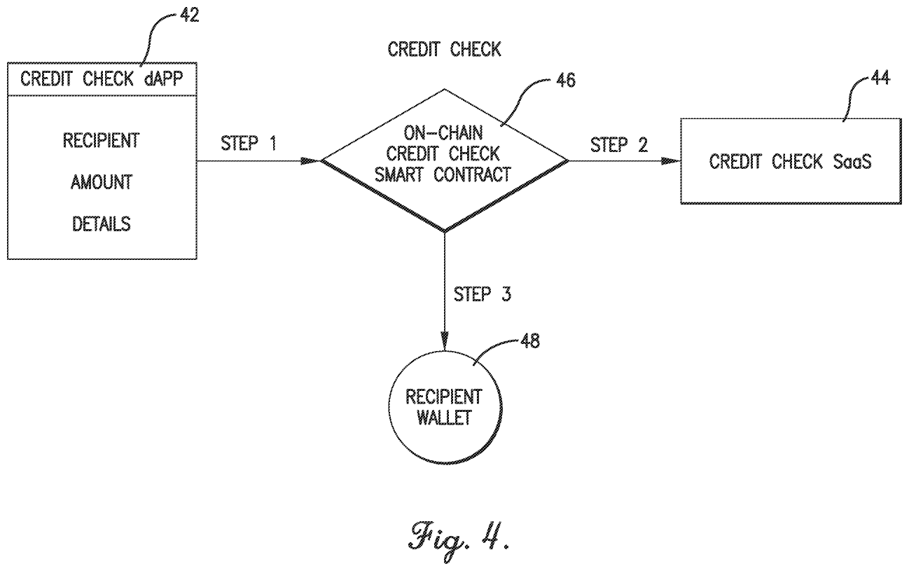

Embodiments of the present invention may also provide credit checks. The flow chart of FIG. 4 shows the functionality and operation of such an implementation of the invention. In this regard, some of the blocks of the flow chart may represent a module segment or portion of code of the computer programs of the present invention which comprises one or more executable instructions for implementing the specified logical function or functions. In some alternative implementations, the functions noted in the various blocks may occur out of the order depicted in FIG. 4. For example, two blocks shown in succession in FIG. 4 may in fact be executed substantially concurrently, or the blocks may sometimes be executed in the reverse order depending upon the functionality involved.

The flow for a credit check goes directly from a dApp 42 operated by a lender to the fraud screening solution 44 via an on-chain credit check smart contract 46. Though this could be done on traditional rails outside of the blockchain, doing it on-chain eliminates some process overhead and additional steps to process the same request.

In steps 1 and 2, the lender uses the dApp 42 to present details of the borrower to the credit check SaaS product 44. The credit check SaaS 44 could be the same product as the fraud analysis SaaS 40 of FIG. 3, with a different set of rules to analyse the credit risk of the borrower. The result of the analysis is stored in the smart contract 46 via a callback, allowing the dApp 42 to retrieve the results. In step 3, the funds are transferred to the borrower 48 only in response to a positive credit check. In some embodiments, the smart contract 46 is configured to transfer the funds only for credit scores exceeding a pre-selected level, such as credit scores of 700 or higher.

The smart contract 46 for credit checks would function similar to the others but would present a different API to capture the required loan and borrower details for the off-chain credit check. Again, the result of the credit check 44 would be returned via a callback to the smart contract 46, and the funds would only be released to the borrower 48 if the credit check passed.

Third party credit check solutions already exist that could be used in this scenario. Equally, other solutions, such as fraud analysis solutions, could be adapted to suit this use case. Similar to entering another vertical market, it would require data to build up the risk strategies in support of this.

As blockchains mature, the present invention could have broader applicability. For instance, centrally governed blockchains could introduce permanent smart contracts to prevent fraud without requiring central infrastructure to process and clear the payments. This could increase overall trust in the currency and increase adoption and use.

Insurance claims are another initial use case for blockchain where the present invention could have some applicability. For example, preventing fraudulent claims using a smart contract to do an initial screen of a claim before it enters the processing queue could save companies costs incurred in manually (or automatically) processing those claims.

Other embodiments of the invention allow a payer, payee, or other participant in a blockchain transaction to indicate their risk threshold for a fraudulent payment. Prior art fraud detection solutions issue a recommendation in the form of Accept, Deny or Challenge. Payers, payees, and/or other participants to a financial transaction must accept these recommendations.

In one embodiment of the present invention, the fraud/financial analysis solution 28 may provide a numerical prediction/probability of fraud, and the payer or payee may choose to cancel payments with a fraud probability greater than 80%. Thus, a payer, payee, or other participant in a blockchain transaction may indicate the level of fraud probability they are willing to accept before completing a blockchain transaction.

In one embodiment, this is accomplished with a scoring process. For example, ‘Soft deny where total spend for a card in 7 days is greater than $1000’ could become ‘Score 500 where total spend for a card in 7 days is greater than $1000’. Then, a payer or other participant may indicate their risk tolerance for such a score. Each rule is given a score, and the participant can decide what their threshold is. For example, a participant may decide that a score of greater than 800 should be a Deny and below that should be an Accept, completely omitting the Challenge. Another participant may prefer to Deny>800, Accept<700 and Challenge between 700 and 800.

The fraud analysis and/or financial analysis solution 28 of the present invention may include AI/Machine Learning components that use a classification model to determine the probability that a given transaction is fraud and output that probability between 0 and 1.

In this invention, the payer, payee, or other participant in the blockchain transaction would provide a threshold value as part of the payment payload. The on-chain smart contract would test the score from the fraud screening service against this threshold, and fail the fraud screening if the score from the service exceeds the threshold.

Because the on-chain smart contract is paired with an off-chain SaaS, it can cater to the response expected from the off-chain solution. If this is a score, the smart contract would have a reasonable default but allow end users to override this with a parameter in the payment request.

Other embodiments of the invention implement the same scoring/probability assessment for assessing a participant's risk level for money laundering, credit worthiness, and/or improper transactions.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, later, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the invention has been described with reference to the embodiments illustrated in the attached drawing figures, it is noted that equivalents may be employed, and substitutions made herein without departing from the scope of the invention as recited in the claims.

Having thus described various embodiments of the invention, what is claimed as new and desired to be protected by Letters Patent includes the following:

1. A computer-implemented method of detecting fraud in a blockchain transaction, the method comprising:
receiving a payment request to initiate a blockchain payment;
using an on-chain payment splitting smart contract to split the payment request into a first fraud check leg and a second payment leg;
calling an on-chain fraud screening smart contract to initiate a fraud analysis from a source that is not on the blockchain;
receiving results of the fraud analysis at the fraud screening smart contract;
transferring the results of the fraud analysis to the payment splitting smart contract;
if the results of the fraud analysis indicates potential fraud, cancelling the second payment leg with the payment splitting smart contract; and
if the results of the fraud analysis do not indicate potential fraud, completing the second leg of the payment request with the payment splitting smart contract to transfer digital assets in accordance with the payment request.

2. The method as set forth in claim 1, wherein the payment request includes data relevant to the payment request, wherein the source of the fraud analysis considers the data in the fraud analysis.

3. The method as set forth in claim 1, wherein the payment splitting smart contract and fraud screening smart contract are integrated into a single smart contract.

4. The method as set forth in claim 1, wherein the digital assets are transferred from a digital wallet of a payer to a digital wallet of the payee.

5. The method as set forth in claim 1, wherein the source of the fraud analysis considers data from at least one blockchain in the fraud analysis.

6. The method as set forth in claim 1, wherein the source of the fraud analysis is a software as a service fraud detection service.

7. The method as set forth in claim 1, wherein the payment request is received from a digital payment source selected from the group consisting of a decentralized application, a digital wallet, and a smart contract.

8. The method as set forth in claim 1, wherein the source of the fraud analysis includes artificial intelligence and machine learning components and returns a fraud probability classification.

9. The method as set forth in claim 8, wherein a participant in the blockchain transaction may indicate a fraud probability classification above which the blockchain transaction should be considered fraudulent.

10. A method of detecting fraud in a blockchain transaction, the method comprising:
receiving a blockchain payment to a smart contract;
calling an on-chain fraud analysis smart contract to initiate a fraud analysis from a source that is not on the blockchain;
receiving results of the fraud analysis at the smart contract;
if the results of the fraud analysis indicates potential fraud, cancelling the payment with the smart contract; and
if the results of the fraud analysis do not indicate potential fraud, completing the payment.

11. The method as set forth in claim 10, wherein the payment includes data relevant to the blockchain transaction, wherein the source of the fraud analysis considers the data in the fraud analysis.

12. The method as set forth in claim 10, wherein the smart contract comprises a payment splitting smart contract.

13. The method as set forth in claim 10, wherein the completing the payment step comprises transferring digital assets from a digital wallet of a payer to a digital wallet of a payee.

14. The method as set forth in claim 10, wherein the source of the fraud analysis considers data from at least one blockchain in the fraud analysis.

15. The method as set forth in claim 10, wherein the source of the fraud analysis is a software as a service fraud detection service.

16. The method as set forth in claim 10, wherein the source of the fraud analysis includes artificial intelligence and machine learning components and returns a fraud probability classification.

17. The method as set forth in claim 16, wherein a participant in the blockchain transaction may indicate a fraud probability classification above which the blockchain transaction should be considered fraudulent.

18. A method of detecting an improper transaction in a blockchain transaction, the method comprising:
receiving a blockchain payment;
calling an on-chain smart contract to initiate a financial analysis from a source that is not on the blockchain to detect a possible improper transaction;
receiving results of the financial analysis at the smart contract;
if the results of the financial analysis indicates a potential improper transaction, cancelling the blockchain payment with the smart contract; and
if the results of the financial analysis do not indicate a potential improper transaction, completing the blockchain payment to transfer digital assets from a payer to a payee.

19. The method as set forth in claim 18, wherein the improper transaction detected by the financial analysis is selected from the group consisting of fraud by a payee, fraud by a payer, a money laundering attempt by the payee, and a money laundering attempt by the payer.

20. The method as set forth in claim 18, wherein the payer is a borrower and the payee is a lender, and wherein the improper transaction is a failed credit check.

21. The method as set forth in claim 18, wherein the blockchain payment is received from a digital payment source selected from the group consisting of a decentralized application, a digital wallet, and a smart contract.

22. The method as set forth in claim 18, wherein the source of the financial analysis includes artificial intelligence and machine learning components and returns an improper transaction probability classification.

23. The method as set forth in claim 22, wherein a participant in the blockchain transaction may indicate an improper transaction probability classification above which the blockchain transaction should be considered improper.
